(19) United States
(12) Patent Application Publication
(10) Pub. No.: US 2022/0006148 A1
(43) Pub. Date: Jan. 6, 2022

(54) BATTERY PRESSURE DETECTION APPARATUS

(71) Applicant: AMOGREENTECH CO., LTD., Gimpo-si, Gyeonggi-do (KR)

(72) Inventor: Inyong SEO, Seoul (KR)

(73) Assignee: AMOGREENTECH CO., LTD., Gimpo-si, Gyeonggi-do (KR)

(21) Appl. No.: 17/292,337

(22) PCT Filed: Nov. 4, 2019
(86) PCT No.: PCT/KR2019/014851

§ 371 Date: May 7, 2021

(30) Foreign Application Priority Data
Nov. 9, 2018 (KR) 10-2018-0137562

(51) Int. Cl. H01M 50/242; H01M 10/0585; H01M 10/48; H01M 10/42; H01M 50/105

(52) U.S. Cl. CPC H01M 50/242; H01M 10/0585; H01M 2200/20; H01M 10/425; H01M 50/105; H01M 10/48

(57) ABSTRACT

Disclosed is a battery pressure detection apparatus, which operates in a short mode when a pressure of a standard level or more is applied to a battery, and recovers after the short mode operation to allow the repeated use. The disclosed battery pressure detection apparatus disposes a lower electrode under an upper electrode, interposes an elastic layer having conductive bodies distributed and disposed therein between the upper electrode and the lower electrode, and has a void disposed in at least one of an upper portion and a lower portion of the elastic layer.

### TECHNICAL FIELD

The present disclosure relates to a battery pressure detection apparatus, and more specifically, to a battery pressure detection apparatus for detecting a pressure due to swelling of a pouch type battery.

### BACKGROUND ART

Swelling occurs in a battery by a gas generated by the reaction of an internal chemical material upon charging operation. In the battery, ignition, explosion, or the like may occur when an internal temperature continuously increases in a state where the swelling has occurred upon charging.

Recently, as the ignition, explosion, or the like of the battery mounted on a portable terminal frequently occurs, manufacturers are conducting the research on various battery control technologies for preventing the ignition, explosion, or the like of the battery.

As an example, as a representative method among the battery control technologies, there is a charging blocking method according to a battery temperature. The charging blocking method measures the battery temperature or an internal temperature of the portable terminal through a thermistor, and blocks the charging of the battery when the measured temperature is a standard value or more.

However, there frequently occurs a case where the temperature increases to the standard value or more upon charging even in a normal state in the battery. Since a portable terminal to which the charging blocking method is applied determines a normal battery as an abnormal state, there is a problem in that charging and charging blocking are repeated, thereby increasing a charging time of the battery.

Therefore, the producing industry is continuously researching a technology of preventing the ignition, explosion, or the like of the battery while minimizing the increase in the charging time of the battery.

### SUMMARY OF INVENTION

### Technical Problem

The present disclosure is proposed in consideration of the above circumstances, and an object of the present disclosure is to provide a battery pressure detection apparatus, which operates in a short mode when a pressure of a standard level or more is applied to a battery, thereby preventing the breakage and ignition of the battery due to swelling.

Another object of the present disclosure is to provide a battery pressure detection apparatus, which recovers after a short mode operation due to swelling of a battery, thereby allowing the repeated use.

### Solution to Problem

To achieve the object, a battery pressure detection apparatus according to an exemplary embodiment of the present disclosure includes an upper electrode, a lower electrode disposed under the upper electrode, an elastic layer having conductive bodies distributed and disposed and interposed between the upper electrode and the lower electrode, an upper adhesive layer interposed between the upper electrode and the elastic layer, and a lower adhesive layer interposed between the elastic layer and the lower electrode, in which a void is disposed in at least one of an upper portion and a lower portion of the elastic layer.

The battery pressure detection apparatus according to the exemplary embodiment of the present disclosure may further include a filter layer made of a hard material with a strength of a set strength or more and disposed above the upper adhesive layer or under the lower adhesive layer. At this time, the filter layer may be formed with a third void between one of the upper electrode and the lower electrode and a battery.

### Advantageous Effects of Invention

According to the present disclosure, the battery pressure detection apparatus may interpose the elastic layer having the conductive bodies distributed therein between the first electrode and the second electrode to operate in the short mode when the pressure of the standard level or more is applied to the battery, thereby preventing the breakage and ignition of the battery due to the swelling.

Further, the battery pressure detection apparatus may interpose the upper adhesive layer and the lower adhesive layer between the first electrode and the elastic layer and between the second electrode and the elastic layer to form at least one void, thereby recovering after the short mode operation due to the swelling to allow the repeated use.

Further, the battery pressure detection apparatus may dispose the filter layer between the laminate in which the first electrode, the second electrode, the elastic layer, the upper adhesive layer, and the lower adhesive layer are laminated and the battery, thereby filtering the swelling of the battery occurring upon charging or discharging, and selectively detecting the swelling of the battery due to the gas.

### BRIEF DESCRIPTION OF DRAWINGS

FIGS. 1 to 3 are diagrams for explaining a battery pressure detection apparatus according to an exemplary embodiment of the present disclosure.

FIG. 4 is a cross-sectional diagram in which the battery pressure detection apparatus illustrated in FIG. 2 is vertically cut.

FIG. 5 is a diagram for explaining a modified example of an upper adhesive layer and a lower adhesive layer illustrated in FIG. 2.

FIGS. 6 to 8 are diagrams for explaining a modified example of the battery pressure detection apparatus according to the exemplary embodiment of the present disclosure.

FIG. 9 is a cross-sectional diagram in which the battery pressure detection apparatus illustrated in FIG. 6 is vertically cut.

FIGS. 10 and 11 are diagrams for explaining a filter layer illustrated in FIG. 6.

### DESCRIPTION OF EMBODIMENTS

Hereinafter, the most preferred exemplary embodiments of the present disclosure will be described with reference to the accompanying drawings in order to specifically describe the exemplary embodiments such that those skilled in the art to which the present disclosure pertains may easily implement the technical spirit of the present disclosure. First, in adding reference numerals to the components of each drawing, it should be noted that the same components have the same reference numerals as much as possible even if they are illustrated in different drawings. Further, in describing the present disclosure, when it is determined that the detailed description of the related well-known configuration or function may obscure the gist of the present disclosure, the detailed description thereof will be omitted.

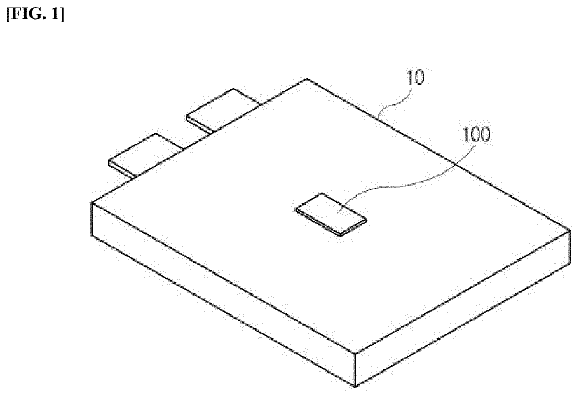

Referring to FIG. 1, a battery pressure detection apparatus 100 according to an exemplary embodiment of the present disclosure is disposed on one surface of a pouch type battery 10. The battery pressure detection apparatus 100 detects a pressure applied by swelling of the battery 10. The battery pressure detection apparatus 100 operates in a short mode when the pressure applied by the swelling of the battery 10 exceeds a standard pressure, thereby preventing the breakage and ignition of the battery 10.

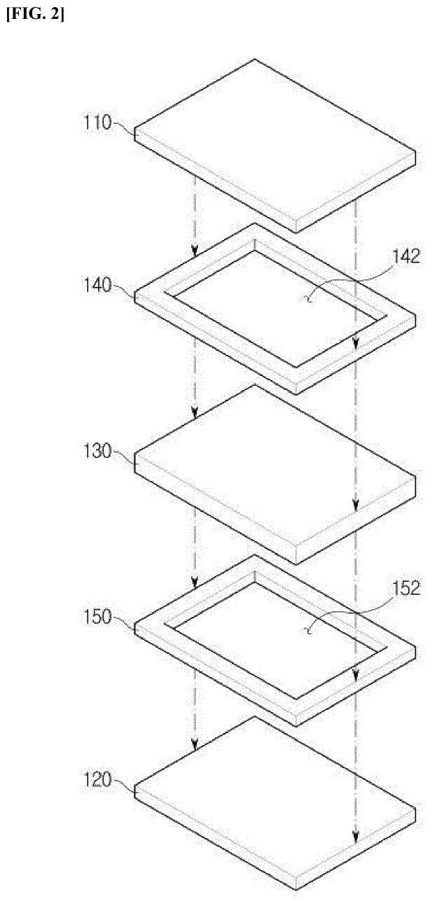

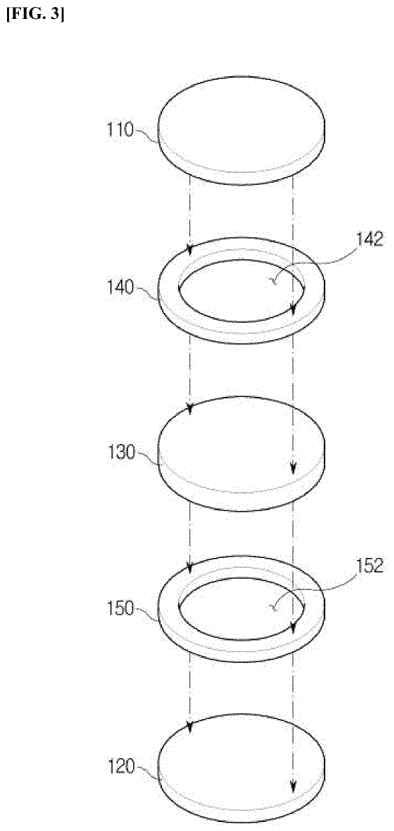

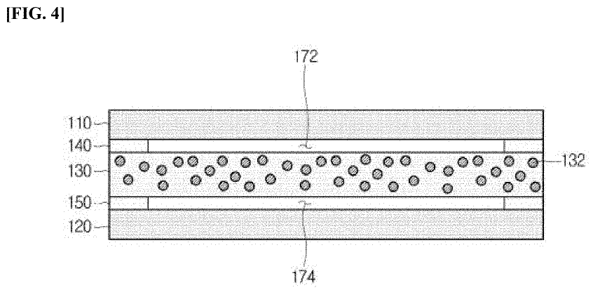

Referring to FIGS. 2 to 4, the battery pressure detection apparatus 100 according to the exemplary embodiment of the present disclosure is configured to include an upper electrode 110, a lower electrode 120, an elastic layer 130, an upper adhesive layer 140, and a lower adhesive layer 150.

The upper electrode 110 is disposed above the lower electrode 120. At this time, the upper electrode 110 and the lower electrode 120 may be formed in the same shape. The upper electrode 110 and the lower electrode 120 are formed in a plate shape of a predetermined shape. As an example, the upper electrode 110 and the lower electrode 120 are formed in a plate shape such as a circle or a square.

The upper electrode 110 and the lower electrode 120 are formed by processing a conductive film such as a conductive tape or a conductive film (layer) in a shape such as a circle or a square.

The elastic layer 130 is interposed between the upper electrode 110 and the lower electrode 120. The elastic layer 130 is formed in a plate shape of a predetermined shape and interposed between the upper electrode 110 and the lower electrode 120. At this time, as an example, the elastic layer 130 is formed in the same shape as the upper electrode 110 and the lower electrode 120 and interposed between the upper electrode 110 and the lower electrode 120.

The elastic layer 130 operates in a short mode when a pressure of a certain level or more is applied by swelling of the battery 10. To this end, the elastic layer 130 is made of a conductive material having conductive bodies distributed therein.

The elastic layer 130 may have the conductive bodies distributed and disposed therein, and be made of a conductive material formed with a plurality of pores. As an example, the elastic layer 130 may be an electrically conductive membrane film formed by electrospinning a conductive member such as a conductive wire, a conductive powder, or a conductive ball together with a conductive nano web.

The elastic layer 130 may have the conductive bodies distributed and disposed therein, and also be made of a conductive material not formed with pores. The elastic layer 130 may be composed of an inorganic material sheet of an inorganic hole to be formed to have a relatively thin thickness. As an example, the elastic layer 130 may be a urethane film having a conductive member, such as a silver nano wire or a silver particle, distributed and disposed therein.

As described above, the battery pressure detection apparatus 100 may interpose the elastic layer 130 having the conductive bodies distributed therein between the upper electrode 110 and the lower electrode 120 to operate in a short mode when a pressure of a standard level or more is applied to the battery 10, thereby preventing the breakage and ignition of the battery 10 due to swelling.

The upper adhesive layer 140 is interposed between the upper electrode 110 and the elastic layer 130. At this time, the upper adhesive layer 140 may be composed of a film having adhesive layers formed on both surfaces thereof. The upper adhesive layer 140 is formed in a frame shape and formed with a first void 172 between the upper electrode 110 and the elastic layer 130. That is, the upper adhesive layer 140 is formed in a plate shape formed with a first hole 142 of a predetermined shape and interposed between the upper electrode 110 and the elastic layer 130. The first hole 142 is formed with the first void 172 and in the first void 172, a lower surface of the upper electrode 110 is disposed on an upper portion thereof, an upper surface of the elastic layer 130 is disposed on a lower portion thereof, and the upper adhesive layer 140 is disposed on a side surface thereof.

The lower adhesive layer 150 is interposed between the elastic layer 130 and the lower electrode 120. At this time, the lower adhesive layer 150 may be composed of a film having adhesive layers formed on both surfaces thereof. The lower adhesive layer 150 is formed in a frame shape and formed with a second void 174 between the elastic layer 130 and the lower electrode 120. That is, the lower adhesive layer 150 is formed in a plate shape formed with a second hole 152 of a predetermined shape and interposed between the elastic layer 130 and the lower electrode 120. The second hole 152 is formed with the second void 174, and in the second void 174, a lower surface of the elastic layer 130 is disposed on an upper portion thereof, an upper surface of the lower electrode 120 is disposed on a lower portion thereof, and the lower adhesive layer 150 is disposed on a side surface thereof.

At this time, although it has been illustrated and described that the battery pressure detection apparatus 100 interposes the upper adhesive layer 140 formed with the first hole 142 between the upper electrode 110 and the elastic layer 130 and interposes the lower adhesive layer 150 formed with the second hole 152 between the elastic layer 130 and the lower electrode 120 to form the first void 172 and the second void 174, the battery pressure detection apparatus 100 is not limited thereto and may also form only one void.

That is, the battery pressure detection apparatus 100 may also interpose the upper adhesive layer 140 formed with the first hole 142 between the upper electrode 110 and the elastic layer 130, and interpose the lower adhesive layer 150 not formed with the hole between the elastic layer 130 and the lower electrode 120 to form only the first void 172.

Of course, the battery pressure detection apparatus 100 may also interpose the upper adhesive layer 140 not formed with the hole between the upper electrode 110 and the elastic layer 130 and interpose the lower adhesive layer 150 formed with the second hole 152 between the elastic layer 130 and the lower electrode 120 to form only the second void 174.

Meanwhile, since the battery pressure detection apparatus 100 may not recover and reuse the elastic layer 130 if any one of the first void 172 and the second void 174 is not formed, at least one of the first void 172 and the second void 174 should be formed.

The upper adhesive layer 140 and the lower adhesive layer 150 may also be formed with the voids having at least one opening. That is, the upper adhesive layer 140 may be formed with the first void 172 having at least one surface of four side surfaces opened, and the lower adhesive layer 150 may be formed with the second void 174 having at least one surface of four side surfaces opened.

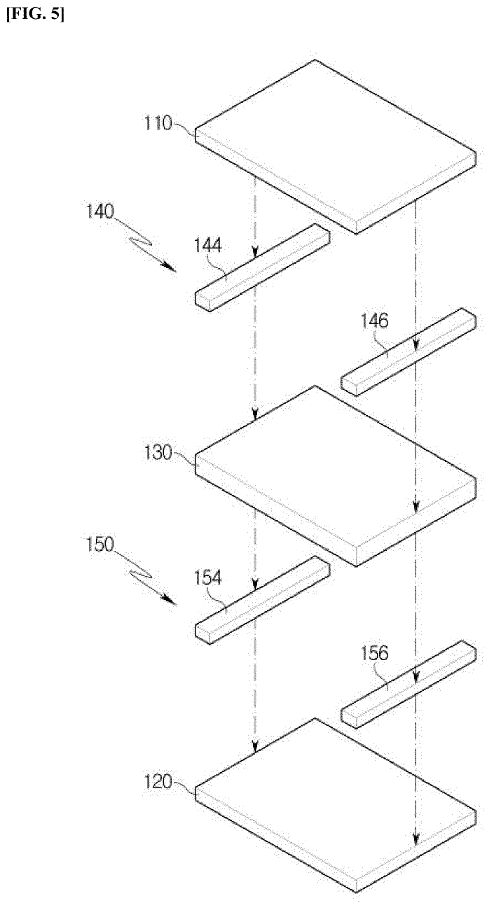

As an example, referring to FIG. 5, the upper adhesive layer 140 is composed of a first upper adhesive layer 144 and a second upper adhesive layer 146. The first upper adhesive layer 144 and the second upper adhesive layer 146 are interposed between the upper electrode 110 and the elastic layer 130. The first upper adhesive layer 144 is disposed to contact one sides of the upper electrode 110 and the elastic layer 130 between the upper electrode 110 and the elastic layer 130. The second upper adhesive layer 146 is disposed to contact the other sides of the upper electrode 110 and the elastic layer 130 between the upper electrode 110 and the elastic layer 130. As a result, the first upper adhesive layer 144 and the second upper adhesive layer 146 are formed with the first void 172 having openings formed in two facing surfaces among four side surfaces of the battery pressure detection apparatus 100.

The lower adhesive layer 150 is composed of a first lower adhesive layer 154 and a second lower adhesive layer 156. The first lower adhesive layer 154 and the second lower adhesive layer 156 are interposed between the elastic layer 130 and the lower electrode 120. The first lower adhesive layer 154 is disposed to contact one sides of the elastic layer 130 and the lower electrode 120 between the elastic layer 130 and the lower electrode 120. The second lower adhesive layer 156 is disposed to contact the other sides of the elastic layer 130 and the lower electrode 120 between the elastic layer 130 and the lower electrode 120. As a result, the first lower adhesive layer 154 and the second lower adhesive layer 156 are formed with the second void 174 having openings formed in two facing surfaces among the four side surfaces of the battery pressure detection apparatus 100.

The upper adhesive layer 140 and the lower adhesive layer 150 may be made of an inorganic material such as a membrane. The upper adhesive layer 140 and the lower adhesive layer 150 may be made of the inorganic material, thereby detecting the pressure due to the swelling of the battery 10 while minimizing the thicknesses thereof.

At this time, the upper adhesive layer 140 and the lower adhesive layer 150 may also be made of a material such as a PET. However, since the material has a stronger strength and is thicker than those of the inorganic material, it is preferably used only in the case of detecting a relatively high pressure.

Since the battery pressure detection apparatus 100 does not detect a low pressure in the case of using the upper adhesive layer 140 and the lower adhesive layer 150 which are an organic material, there may occur a case of not accurately detecting the swelling of the battery 10. Therefore, the battery pressure detection apparatus 100 is composed of the upper adhesive layer 140 and the lower adhesive layer 150 made of the inorganic material to accurately detect the swelling of the battery 10 even while minimizing the thicknesses thereof.

The upper adhesive layer 140 and the lower adhesive layer 150 may be formed with grooves forming an air passage through a cut line process or the like to discharge the air flowing into the voids (the first void 172 and the second void 174) to the outside upon manufacturing process. As a result, the battery pressure detection apparatus 100 facilitates the manufacturing while minimizing defects.

As described above, the battery pressure detection apparatus 100 may interpose the upper adhesive layer 140 and the lower adhesive layer 150 between the upper electrode 110 and the elastic layer 130 and between the lower electrode 120 and the elastic layer 130 to form at least one void, thereby recovering after the short mode operation due to the swelling to allow the repeated use.

Meanwhile, swelling occurs in a certain portion of the battery 10 of an aluminum pouch cell type by itself upon charging or discharging. As an example, the swelling of about 30% occurs in the battery 10 of the aluminum pouch cell type upon charging or discharging.

If the aforementioned battery pressure detection apparatus 100 is applied to the battery 10 of the aluminum pouch cell type, the charging or the discharging may be restricted by detecting the swelling occurring upon charging or discharging as swelling due to the generation of a gas inside the battery 10.

Therefore, there is the need for a structure for filtering the swelling occurring upon charging or discharging and detecting only the swelling due to the generation of the gas.

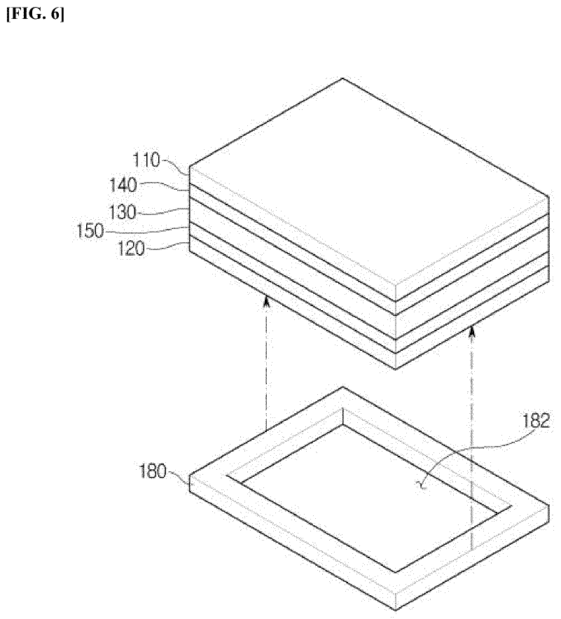

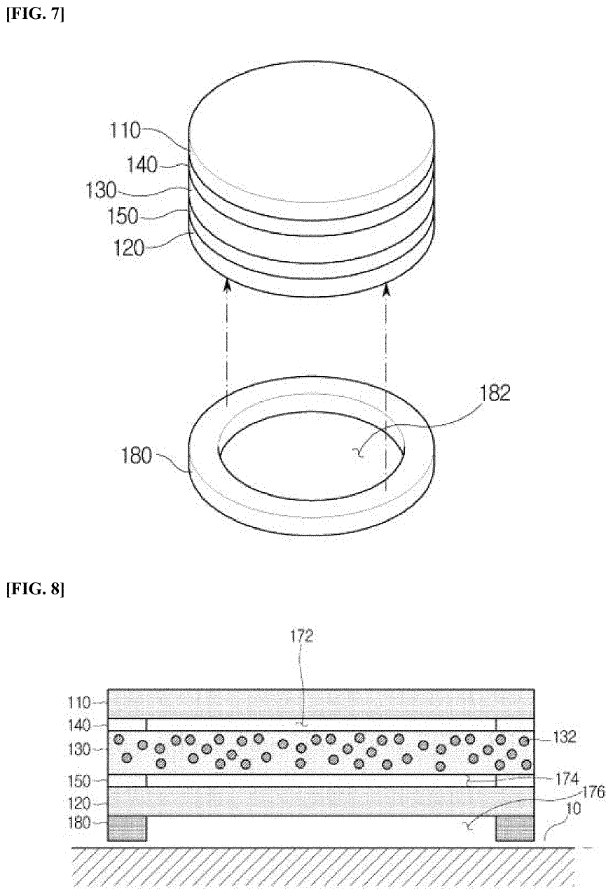

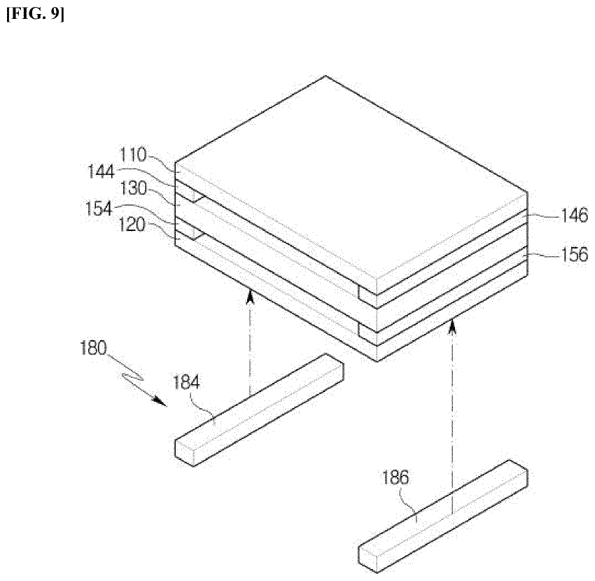

Referring to FIGS. 6 to 8, the battery pressure detection apparatus 100 may further include a filter layer 180 for filtering the swelling occurring upon charging or discharging.

The filter layer 180 is disposed on a lower surface of the laminate in which the upper electrode 110, the lower electrode 120, the elastic layer 130, the upper adhesive layer 140, and the lower adhesive layer 150 are laminated. Here, the lower surface of the laminate means one surface of the laminate facing the battery 10. Therefore, the filter layer 180 may be disposed above the upper electrode 110 or under the lower electrode 120.

The filer layer 180 is formed in a frame shape and disposed on the lower surface of the laminate. That is, the filter layer 180 is formed with a third hole 182 of a predetermined shape, and formed of a plate shape which is a hard material. The third hole 182 is formed with a third void 176, and in the third void 176, the upper surface of the upper electrode 110 or the lower surface of the lower electrode 120 is disposed on an upper portion thereof, the filter layer 180 is disposed on a side surface thereof, and the battery 10 is disposed on a lower portion thereof.

The filter layer 180 is made of a hard material with a strength of a certain level or more. As an example, the filter layer 180 is a PET which is a hard material.

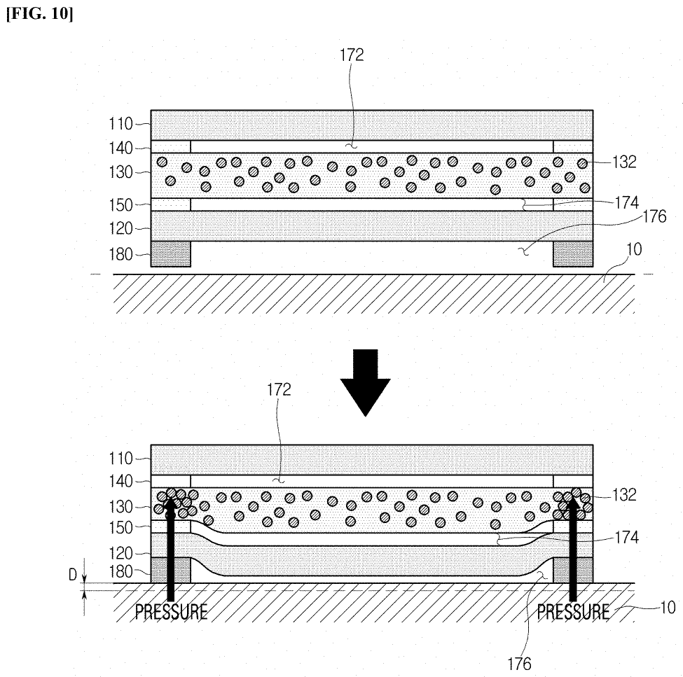

Referring to FIG. 9, the filter layer 180 may also be composed of a first filter layer 184 and a second filter layer 186.

The first filter layer 184 and the second filter layer 186 are disposed on the lower surface of the laminate. At this time, the first filter layer 184 is disposed to contact one side surface of the laminate on the lower surface of the laminate. The second filter layer 186 is disposed to contact the other side surface of the laminate on the lower surface of the laminate. As a result, the first filter layer 184 and the second filter layer 186 are formed with the third voids 176 having two facing surfaces of four side surfaces of the battery pressure detection apparatus 100 opened.

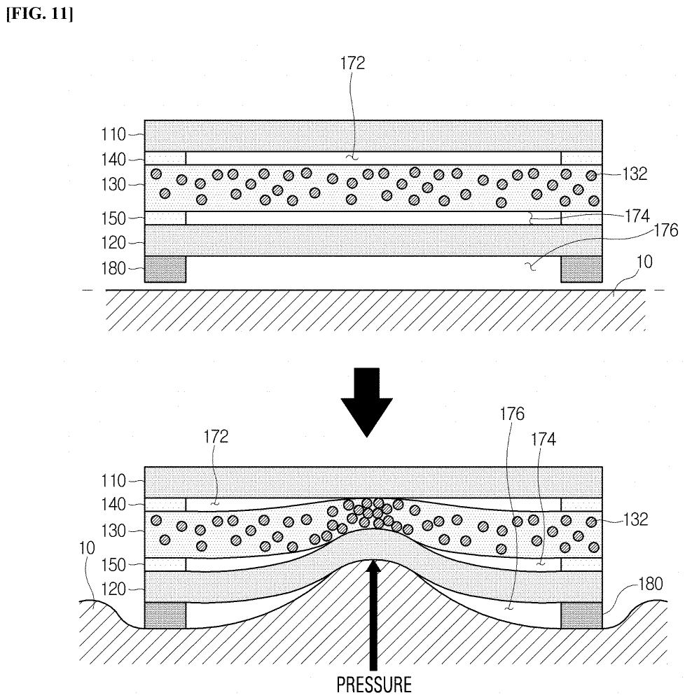

Referring to FIG. 10, the swelling (D) occurring upon charging or discharging occurs evenly on the entire surface of the battery 10. At this time, the battery pressure detection apparatus 100 receives a pressure due to the swelling occurring upon charging or discharging, but the filter layer 180 distributes the pressure, such that the pressure is not applied to the elastic layer 130. Therefore, the elastic layer 130 does not operate in a short mode, such that the occurrence of the swelling of the battery 10 is not detected.

Referring to FIG. 11, the swelling occurring due to the gas occurs on a specific portion (mainly, the center of the battery 10) of the battery 10. At this time, the swelling of the battery 10 concentrates on the third void 176 formed by the filter layer 180, such that the pressure is applied to the elastic layer 130. Therefore, the elastic layer 130 operates in the short mode, such that the occurrence of the swelling of the battery 10 is detected.

As described above, the battery pressure detection apparatus 100 may dispose the filter layer 180 between the laminate in which the upper electrode 110, the lower electrode 120, the elastic layer 130, the upper adhesive layer 140, and the lower adhesive layer 150 are laminated and the battery 10 to filter the swelling of the battery 10 occurring upon charging or discharging and to selectively detect the swelling of the battery 10 due to the gas.

Although the preferred exemplary embodiments of the present disclosure have been described above, it is understood that the present disclosure may be modified in various forms, and those skilled in the art may practice various modified examples and changed examples without departing from the scope of the claims of the present disclosure.

1. A battery pressure detection apparatus comprising:
a first electrode;
a second electrode disposed above one surface of the first electrode;
an elastic layer having conductive bodies distributed and disposed therein, and interposed between the first electrode and the second electrode;
an upper adhesive layer interposed between the first electrode and the elastic layer; and
a lower adhesive layer interposed between the elastic layer and the second electrode,
wherein a void is disposed in at least one of an upper portion and a lower portion of the elastic layer.

2. The battery pressure detection apparatus of claim 1,
wherein the elastic layer is an electrically conductive membrane formed by electrospinning the conductive bodies comprising at least one of a conductive wire, a conductive powder, and a conductive ball together with a conductive nano web.

3. The battery pressure detection apparatus of claim 1,
wherein the elastic layer is made of a conductive material in which a plurality of pores are formed.

4. The battery pressure detection apparatus of claim 1, comprising:
one or more of a first void formed between the first electrode and the elastic layer; and
a second void formed between the elastic layer and the second electrode.

5. The battery pressure detection apparatus of claim 1,
wherein the upper adhesive layer has a frame shape formed with a first hole.

6. The battery pressure detection apparatus of claim 1,
wherein the upper adhesive layer is formed with a first void between the first electrode and the elastic layer, and
wherein in the first void, a lower surface of the first electrode is disposed on an upper portion thereof, an upper surface of the elastic layer is disposed on a lower portion thereof, and the upper adhesive layer is disposed on a side portion thereof.

7. The battery pressure detection apparatus of claim 1,
wherein the upper adhesive layer comprises:
a first upper adhesive layer interposed between the first electrode and the elastic layer, and disposed to be biased toward one sides of the first electrode and the elastic layer; and
a second upper adhesive layer interposed between the first electrode and the elastic layer, and disposed to be biased toward the other sides of the first electrode and the elastic layer.

8. The battery pressure detection apparatus of claim 7,
wherein the upper adhesive layer is formed with a first void having one or more openings.

9. The battery pressure detection apparatus of claim 1,
wherein the lower adhesive layer has a frame shape formed with a second hole.

10. The battery pressure detection apparatus of claim 1,
wherein the lower adhesive layer is formed with a second void between the elastic layer and the second electrode, and
wherein in the second void, a lower surface of the elastic layer is disposed on an upper portion thereof, an upper surface of the second electrode is disposed on a lower portion thereof, and the lower adhesive layer is disposed on a side portion thereof.

11. The battery pressure detection apparatus of claim 1,
wherein the lower adhesive layer comprises:
a first lower adhesive layer interposed between the elastic layer and the second electrode, and disposed to be biased toward one sides of the elastic layer and the second electrode; and
a second lower adhesive layer interposed between the elastic layer and the second electrode, and disposed to be biased toward the other sides of the elastic layer and the second electrode.

12. The battery pressure detection apparatus of claim 11,
wherein the lower adhesive layer is formed with a second void having one or more openings.

13. The battery pressure detection apparatus of claim 1, further comprising: a filter layer made of a hard material with a strength of a set strength or more and disposed above the upper adhesive layer or under the lower adhesive layer.

14. The battery pressure detection apparatus of claim 13,
wherein the filter layer is formed in a frame shape formed with a third hole.

15. The battery pressure detection apparatus of claim 13,
wherein the filter layer is formed with a third void between one of the first electrode and the second electrode and a battery, and
wherein in the third void, an upper surface of the first electrode or a lower surface of the second electrode is disposed on an upper portion thereof, an upper surface of the battery is disposed on a lower portion thereof, and the filter layer is disposed on a side portion thereof.

16. The battery pressure detection apparatus of claim 13,
wherein the filter layer is formed with a third void having one or more openings.

17. The battery pressure detection apparatus of claim 13, wherein the filter layer comprises:
a first filter layer disposed above the upper adhesive layer or under the lower adhesive layer, and disposed to be biased toward one side surface of the upper adhesive layer or one side surface of the lower adhesive layer; and
a second filter layer disposed above the upper adhesive layer or under the lower adhesive layer, and disposed to be biased toward the other side surface of the upper adhesive layer or the other side surface of the lower adhesive layer.
